(19) United States
(12) Patent Application Publication
(10) Pub. No.: US 2016/0178992 A1
(43) Pub. Date: Jun. 23, 2016

(54) Fringe projector and method of illuminating a scenery with a variable fringe pattern

(71) Applicant: SICK AG, Waldkirch (DE)

(72) Inventor: Florian SCHNEIDER, Waldkirch (DE)

(21) Appl. No.: 14/951,722

(22) Filed: Nov. 25, 2015

(30) Foreign Application Priority Data
Dec. 19, 2014 (DE) 10 2014 119 126.9

(51) Int. Cl. G03B 15/06; H04N 13/02; G02B 3/14; G02B 26/08; G02B 3/00; G02B 3/06

(52) U.S. Cl. CPC G03B 15/06; G02B 3/005; G02B 3/06; G02B 3/0081; G02B 3/14; G02B 26/0883; H04N 13/02

(57) ABSTRACT

A fringe projector (12) for generating a variable fringe pattern in a scenery (22) is provided, said fringe projector having a light source (16), a fringe generation element (18) for generating the fringe pattern and a settable optical element (20) for the dynamic variation of the fringe pattern. In this respect, the optical element (20) is deformable and a change of shape of the optical element (20) effects a variation of the fringe pattern.

The invention relates to a fringe projector for generating a variable fringe pattern in a scenery, said fringe projector having a light source, a fringe generation element for generating the fringe pattern and a settable optical element for the dynamic variation of the fringe pattern. The invention further relates to a method of illuminating a scenery with a variable fringe pattern in which light is projected via a fringe generation element onto the scenery and in which an optical element in the optical path of the projection is adjusted to dynamically vary the fringe pattern.

The variable fringe pattern generated by a fringe projector is used in a fringe projection method to acquire three-dimensional image data. The combination of at least one fringe projector, at least one video camera and a corresponding evaluation is accordingly a 3D camera which has a large area of use, inter alia for the inspection and measurement of objects in an industrial environment.

For a three-dimensional image detection, the fringe projector illuminates the scenery or the measured object consecutively with patterns of parallel, bright and dark fringes of different widths. Each participating camera takes an image of the scenery on illumination with the respective fringe pattern at a known angle of view for the projection. A time sequence of different brightnesses is thus created for each picture element which is algorithmically evaluated using the geometrical data such as the spacing between the camera and the fringe projector to determine the three-dimensional coordinates of the taken surfaces. The different illuminations arise in a variant as a phase shifting process by a lateral shifting of the fringe pattern, for example by a multiple of 90°. Non-discrete coordinates can thereby also be determined.

The principle just explained of three-dimensional image detection is known and is described, for example, in very exhaustive detail in DE 199 19 584 A1.

A fringe pattern is moved over a surface to detect irregularities in U.S. Pat. No. 4,744,237.

A plurality of slide projectors having different patterns or DLP (digital light processing) projectors having a digital mirror array are typically used as fringe projectors. The majority of slide projectors produce a high system complexity. A DLP projector has very high manufacturing costs despite the fact that a monochromatic illumination is sufficient for the use in a fringe projection process.

U.S. Pat. No. 5,572,368 utilizes cylindrical lenses to generate a fringe pattern for a distance measurement. This fringe pattern is, however, not variable.

It is customary to focus an objective to a specific distance or distance range. Such a variable focus can in particular be achieved by gel lenses or liquid lenses in which the shape and thus the focal length of the lens itself is changed. With a gel lens, a silicone-like liquid is mechanically deformed by means of piezoelectric or inductive actuators. Liquid lenses, for example, utilize the so-called electrowetting effect in that two non-miscible liquids are disposed above one another in a chamber. When a control voltage is applied, the two liquids change their surface tensions in different manners so that the inner boundary surface of the liquids varies its curvature in dependence on the voltage. An electronic sensor having a focus adjustment on the basis of liquid lenses is known from DE 10 2005 015 500 A1 or from DE 20 2006 017 268 U1. However, the fringe pattern is not varied by adjusting the focus.

In a further development of such liquid lenses for focal adjustment, EP 2 071 367 A1 proposes also varying the tilt of the liquid lens by applying different voltages in the peripheral direction. To prevent a taking of blurred images, the camera's own movement is then determined and one or more lenses in the camera are tilted to counteract this own movement.

A further optoelectronic sensor having a liquid lens is disclosed in DE 10 2005 015 500 A1 whose beam shaping properties are asymmetrically variable by an asymmetrical frame or by different electrical potentials at separate electrodes of the lens frame. However, the document does not then explain the purpose for which this can be used.

It is the object of the invention to generate fringe patterns in a simple manner.

This object is satisfied by a fringe projector in accordance with claim 1. A fringe generation element generates a fringe pattern, preferably a light/dark pattern of parallel fringes of different width and brightness, from the light of a light source. The fringe pattern is dynamically varied with the aid of a settable optical element to make a fringe projection method possible. The invention starts from the basic idea of effecting the variation in that the optical element is deformed.

The invention has the advantage that a particularly compact and inexpensive fringe projector is produced. Neither a plurality of projectors are required, as in the case of slides with different fringe patterns, nor does a complex mirror array for a DLP projector with high manufacturing costs have to be used.

The fringe generation element preferably has a cylindrical lens array. The cylindrical lenses focus the light in one axis and thus generate fringes of different brightness. A slide is alternatively also conceivable since the initially fixed fringe pattern of a slide is also dynamically variable by the optical element deformed in accordance with the invention.

A change of shape preferably effects a change of phase and/or of spatial frequency of the fringes of the fringe pattern. Such a change can be obtained comparatively simply by deformation. In addition, a constant variation is possible, for example a phase shift, and thus a limitation to discrete coordinates is canceled.

The optical element preferably has an adaptive lens. At least the focal length of this lens is adjustable. The adaptive lens is preferably a liquid lens or a gel lens. Such lenses provide the desired focusing possibility and are very small in construction and inexpensive in this respect. Depending on the technology, the lens as such or a boundary layer between two non-miscible media of the lens is deformed in this respect.

The adaptive lens preferably has a tilt with respect to the direction of projection. The fringe pattern is not shifted in its phase simply by a focal length change. However, this can be achieved when the adaptive lens is additionally slanted. In this respect, the reference direction is the projection direction, that is the direction of the light beam of the light source or the optical axis of the light source or of its collimation optics.

The sensor preferably has a zoom objective having the adaptive lens. Zoom variations are achieved by focal settings and thus deformations of the adaptive lens. The zoom changes then vary the fringe pattern. The zoom objective preferably has a plurality of adaptive lenses and optionally also one or more non-adaptive lenses.

The adaptive lens preferably has segmented control elements in the peripheral direction. The control elements are, for example, segmented electrodes which control a liquid lens via the electrowetting effect. Segmented actuators, in particular piezo actuators, are furthermore conceivable which locally vary the pressure on a liquid and thereby differently curve a membrane on liquid or which directly deform a gel-like substance of the lens. A non-rotationally symmetrical influencing of the lens which results in an optical tilt is made possible by the segmentation in the peripheral direction. This in turn effects a variation of the fringe pattern.

The optical element preferably has an adaptive prism composed of at least two part elements having an elastic intermediate layer. The two part elements are, for example, transparent plates or even prisms which are tilted differently with respect to one another while deforming the intermediate layer and thus vary the fringe pattern.

The fringe generation element and the optical element are preferably formed as a common element. The common element accordingly has a dual function in that it generates the fringes and varies them by deformation and thus further simplifies the design.

The common element is preferably a deformable cylindrical lens array. The cylindrical lenses are in this respect again preferably manufactured from an elastic material. They can therefore be pulled apart or compressed, whereby the spatial frequency and the phase of the fringes vary.

In an advantageous further development, a 3D camera in accordance with the fringe projection process is provided with a fringe projector in accordance with the invention, with the 3D camera additionally having an image sensor for taking images of the scenery illuminated with the fringe pattern and having an evaluation unit which is configured to calculate three-dimensional image data of the scenery from the fringe pattern and the brightness differences. Such a 3D camera and the calculations for the fringe projection method or phase shift method are known per se. In accordance with the invention, however, a particularly compact and inexpensive 3D camera can be manufactured in which the variable fringe patterns are generated in a particularly simple manner.

In a further aspect the object is satisfied by a corresponding method illuminating a scenery with a variable fringe pattern.

The method in accordance with the invention can be designed in a similar manner as the apparatus and can include further features and shows similar advantages in this respect. Such further features are described in an exemplary, but not exclusive manner in the dependent claims following the independent claims.

The invention will also be explained in the following with respect to further advantages and features with reference to the enclosed drawing and to embodiments. The Figures of the drawing show in:

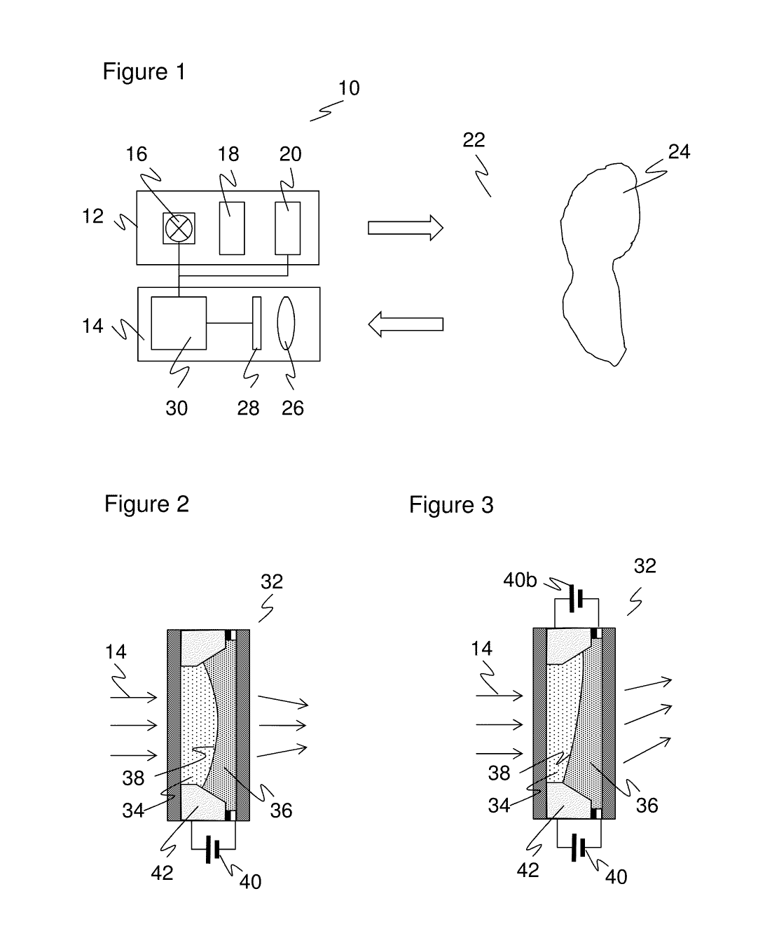

FIG. 1 a block diagram of a 3D camera with a fringe projector;

FIG. 2 a sectional representation of a liquid lens with an adjustable focal length;

FIG. 3 a sectional representation of a liquid lens with an additional variable tilt;

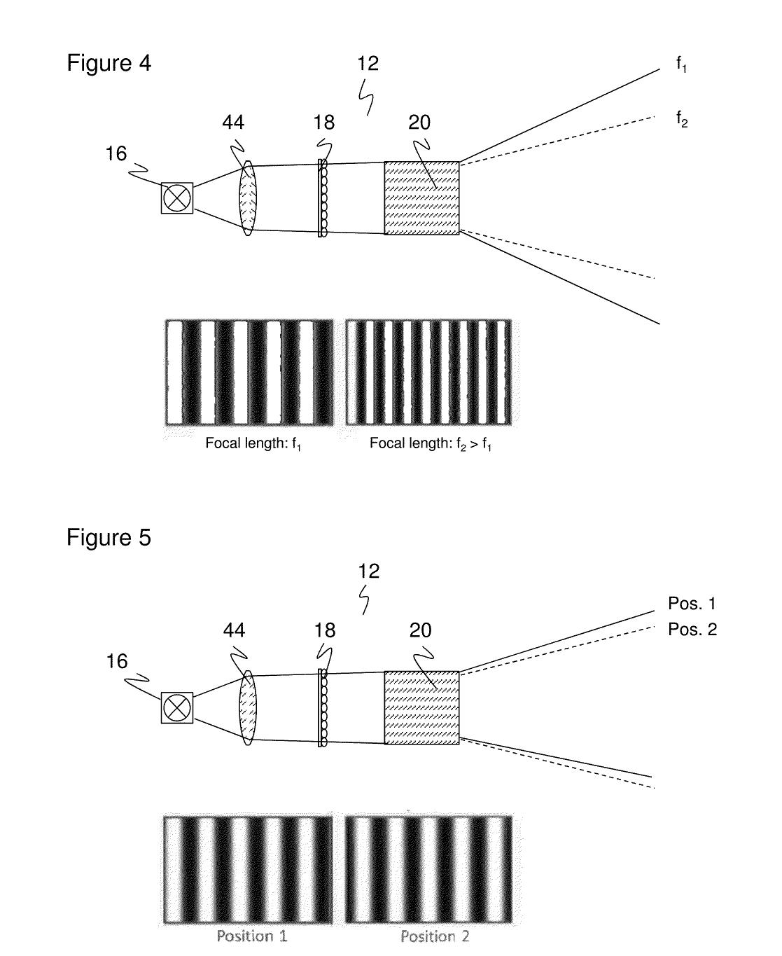

FIG. 4 a sectional representation of a fringe projector with a variable zoom;

FIG. 5 a sectional representation of a fringe projector with a variable tilt;

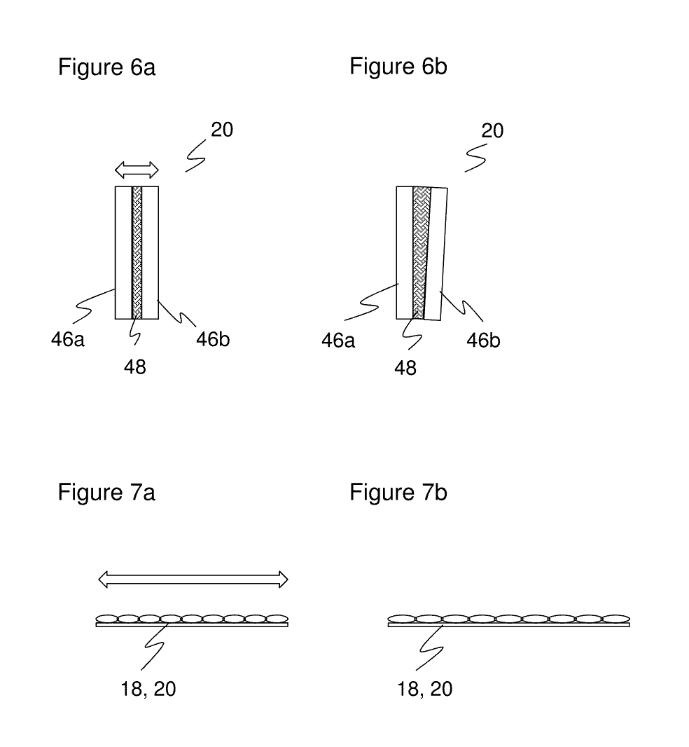

FIG. 6a a schematic representation of an adaptive prism with an elastic intermediate layer for a fringe projector in a starting state;

FIG. 6b a representation of the adaptive prism in accordance with FIG. 6a in a pulled-apart state;

FIG. 7a a representation of a deformable cylindrical lens array in a starting state; and

FIG. 7b a representation of the deformable cylindrical lens array in accordance with FIG. 7a in a pulled-apart state.

FIG. 1 shows a block diagram of a 3D camera 10 which has a fringe projector 12 and a camera 14 for image taking. The fringe projector 12 comprises a light source 16, a fringe generation element 18 and a settable optical element 20. The fringe generation element 18 imparts a fringe pattern on the light of the light source 16, said fringe pattern being dynamically varied by the optical element 20. A variable fringe pattern of light/dark fringes thus arises with which a scenery 22 or an object 24 in the scenery 22 is illuminated. The design of the fringe projector 12 in FIG. 1 is very schematic and, for example, does not show either a collimation optics for the light source 16 or a projection optics, preferably with a small aperture due to the depth of field, for imaging the fringe patter onto the scenery. The fringe projector 12 will be explained in more detail further below with reference to a plurality of embodiments and to the FIGS. 4 to 7.

The camera 14 comprises a reception optics 26, an image sensor 28 and a control and evaluation unit 30. In this respect, the apportionment in FIG. 1 is only to be understood in the sense of functional blocks and it is by all means conceivable that all the elements of the 3D camera 10 are located in a common housing, in the same way as the control and evaluation unit 30 can be at least partly be implemented externally. The reception optics 26 supplies received light from the scenery 22 to the image sensor 28 so that the image sensor 28 takes images of the object 24 illuminated with different fringe patterns. Three-dimensional image data are calculated in a fringe projection process known per se in the control and evaluation unit 30 from the initially two-dimensional image data. For this purpose, the control and evaluation unit 30 also controls the fringe projector and in particular its light source 16 and optical element 20 to generate variable fringe patterns with a time behavior desired for the fringe projection process.

One possibility of varying the fringe pattern and in particular of shifting its phase comprises a movement of an element in the fringe projector 12, for instance by an electromagnetic piezoelectric or electrostatic actuator. The invention, however, provides achieving the variation of the fringe pattern by a deformation of the optical element 20. Adaptive lenses are used for this purpose in some embodiments. FIGS. 2 and 3 schematically show the functional principle of an adaptive lens in the form of a liquid lens 32 in accordance with the electrowetting effect. The operation and also the application will be explained in the following with reference to this liquid lens 32, but other adaptive lenses are equally conceivable, for example those having a liquid chamber and having a membrane which covers it and whose curvature is varied by pressure on the liquid or having lenses with a gel-like, optically transmitting material which is mechanically deformed by an actuator mechanism.

The actively tunable liquid lens 32 has two transparent, non-miscible liquids 34, 36 having different refractive indices and having the same density. The shape of the liquid-to-liquid boundary surface 38 between the two liquids 34, 36 is used for an optical function. The activation is based on the principle of electrowetting which shows a dependence of the surface tension or of the boundary tension on the applied electrical field. It is therefore possible to vary the shape of the boundary layer 38 and thus the optical properties of the liquid lens 32 by an electric control at a terminal 40, whereby corresponding voltages are applied to an electrode 42.

FIG. 2 first shows the longer known variation of the focal properties of the liquid lens 32. The curvature of the boundary layer 38 is varied by a control at the terminal. The refractive behavior is thus varied and, for example, a focal length set.

The tilt of the liquid lens 32 can, however, also be influenced. This is illustrated in FIG. 3 and is based on non-rotationally symmetrically applied voltages with the aid of at least two terminals 40, 40b and of a segmented electrode 42. The boundary layer 38 is accordingly non-rotationally symmetrically deformed, which is utilized for the tilt. FIG. 4 shows by way of example a tilt of the liquid lens 32 which also results in an upward deflection of light in addition to the focusing effect.

FIG. 4 shows an embodiment of the fringe projector 12 which uses a zoom objective as a projection objective for projecting the fringe pattern onto the scenery 22 and simultaneously as a settable optical element 20. The zoom objective is made up of a plurality of lenses of which at least two lenses are liquid lenses. A zoom adjustment therefore does not take place as usual by moving the lenses along the optical axis, but rather by deforming the boundary layer 38 in the liquid lenses. The fringe pattern arises in that a fringe generation element 18 configured as a cylindrical lens array focuses the incident light to form lines. A collimation optics 44 is arranged between the light source 16 and the fringe generation element 18.

The spatial frequency of the lines or fringes of the fringe pattern can be varied with the help of zoom adjustments. This is illustrated at the bottom of FIG. 4 by way of example for two different settings of the zoom. A high switchover frequency between the different patterns can be achieved by the short response times of the liquid lenses.

It is also conceivable to use a simpler projection objective which is not capable of zooming and only comprises a liquid lens. In contrast to what is customary this is then installed in a slightly slanted manner Adjustments to the focal length of the liquid lens then displace the fringe pattern (phase shifting).

FIG. 5 shows a further embodiment of the fringe projector 12. Unlike in the embodiment in accordance with FIG. 4, the optical element 20 is here not a zoom objective, but rather a simple projection objective with a dynamically tiltable liquid lens 32 as in FIG. 3. It is differently also conceivable that it is a zoom objective, with at least one of the participating liquid lenses, however, not only being variable in focal length, but also in the tilt position. FIG. 5 illustrates in the lower part at two different tilt settings how the phase of the fringe pattern is shifted. If a zoom setting is additionally varied, the effects in accordance with FIG. 4 and FIG. 5 are added together and the fringe pattern becomes variable both in the spatial frequency and in the phase.

FIG. 6 shows an embodiment of the settable optical element 20 as an adaptive prism. Two transparent plates 46a-b, which can also per se be prisms in a different aspect, are connected to one another via an elastic layer 48. The effective prismatic angle of this arrangement varies, as illustrated in two settings in accordance with FIG. 6a and FIG. 6b, when an actuator mechanism, not shown, tilts the two plates 46a-b relative to one another while using the properties of the elastic material of the layer 48. This then results in a shift or in a phase change of the fringe pattern in the scenery 22.

FIG. 7 shows an embodiment in which the fringe generation element 18 and the settable optical element 20 are formed as a common element. It is a deformable cylindrical lens array in this example, that is a cylindrical lens array which is manufactured from a deformable and in particular elastic material. The radius of curvature of the cylindrical lenses, their positions and possibly also their mutual spacing are varied by expanding this cylindrical lens array with the aid of an actuator mechanism, again not shown, as illustrated by two expansion positions in accordance with FIGS. 7a and 7b. Fringe patterns adjustable both in spatial frequency and in phase can thus be generated in the scenery 22. A projection objective, which can be a conventional objective or also an objective with adaptive lenses, is preferably also connected downstream in this embodiment. Depending on the characteristic, the projection objective also contributes to the variation of the fringe pattern. The focal position can also be tracked as required with the aid of an adaptive lens of the projection objective.

Various combinations of the presented embodiments are conceivable. A lateral relative movement in the fringe projector can thus, for example, be combined with a zoom objective to vary both the spatial frequency and the phase of the fringe pattern. It is equally conceivable to achieve this dual variation of the fringe pattern in that a liquid lens is set with a slight slant in the zoom objective. The adaptive prism in accordance with FIG. 6 or a deformable cylindrical lens array in accordance with FIG. 7 can furthermore be used together with tilted or tiltable liquid lenses or with a zoom objective based on liquid lenses. This list of combination possibilities is not exclusive.

1. A fringe projector for generating a variable fringe pattern in a scenery, said fringe projector having a light source, a fringe generation element for generating the fringe pattern and a settable optical element for the dynamic variation of the fringe pattern,
wherein the optical element is deformable and a change of shape of the optical element effects a variation of the fringe pattern.

2. The fringe projector in accordance with claim 1,
wherein the fringe generation element has a cylindrical lens array.

3. The fringe projector in accordance with claim 1,
wherein a change of shape effects a variation of the phase and/or spatial frequency of the fringes of the fringe pattern.

4. The fringe projector in accordance with claim 1,
wherein the optical element has an adaptive lens.

5. The fringe projector in accordance with claim 4,
wherein the adaptive lens is a liquid lens or a gel lens.

6. The fringe projector in accordance with claim 4,
wherein the adaptive lens has a tilt with respect to the direction of projection.

7. The fringe projector in accordance with claim 4,
which has a zoom objective including the adaptive lens.

8. The fringe projector in accordance with claim 4,
wherein the adaptive lens has segmented control elements in the peripheral direction.

9. The fringe projector in accordance with claim 1,
wherein the optical element has an adaptive prism composed of at least two part elements having an elastic intermediate layer.

10. The fringe projector in accordance with claim 1,
wherein the fringe generation element and the optical element are formed as a common element.

11. The fringe projector in accordance with claim 10,
wherein the common element is a deformable cylindrical lens array.

12. A 3D camera in accordance with the fringe projection method having a fringe projector having a light source, a fringe generation element for generating the fringe pattern and a settable optical element for the dynamic variation of the fringe pattern, wherein the optical element is deformable and a change of shape of the optical element effects a variation of the fringe pattern, the 3D camera having an image sensor for taking images of a scenery illuminated with the fringe pattern and having an evaluation unit which is configured to calculate three-dimensional image data of the scenery from the fringe pattern and brightness differences of the images.

13. A method of illuminating a scenery with a variable fringe pattern in which light is projected via a fringe generation element onto the scenery and in which an optical element in the optical path of the projection is adjusted to dynamically vary the fringe pattern, wherein the optical element is deformed and the fringe pattern is varied by the change of shape of the optical element.
